(19) United States
(12) Patent Application Publication
(10) Pub. No.: US 2011/0101810 A1
(43) Pub. Date: May 5, 2011

(54) SERIAL CONNECTION STRUCTURE OF DIRECT-DRIVE MOTOR

(76) Inventors: Ming-Hung HSIEH, Taichung City (TW); Chi-Lu Li, Taichung City (TW)

(21) Appl. No.: 12/612,174

(22) Filed: Nov. 4, 2009

(51) Int. Cl. H02K 16/00

(52) U.S. Cl. 310/114

(57) ABSTRACT

A serial connection structure of a direct-drive motor, including a central shaft, a housing, at least two rotors and stators of the same number as the rotors. The central shaft has a predetermined length. The housing has an internal space and is coaxially fitted around the central shaft. The rotors are received in the housing and coaxially rotatably fitted on the central shaft at predetermined intervals. The stators are received in the housing and coaxially fitted around the central shaft corresponding to the rotors respectively. The stators are spaced from the rotors by a predetermined distance. The serial connection structure is applicable to a generator or a wind power generator system without extra connecting with any transmission gear system. Therefore, the number of components is decreased, the maintenance cost is lowered and the service is simplified.

### BACKGROUND OF THE INVENTION

The present invention relates generally to motor technique, and more particularly to a serial connection structure of a direct-drive motor, which is applicable to, but not limited to, a generator or a wind power generator system.

Following the rapid increase of the world's population, there is a crisis of energy. Also, global warming has become more and more serious. It is a worldwide trend to emphasize the concept of environmental protection and make effort in developing renewable energy sources as alternative energy sources. For example, hydraulic power generation systems, thermal power generation systems and wind power generation systems have been widely developed to minimize pollution to the environment. In these power generation systems, hydraulic power generation systems require plentiful amount of water and thermal power generation systems still tend to cause pollution, while only wind power generation systems rely on inexhaustible natural energy resource and are free from the problem of fuel. Moreover, wind power generation systems are built at lower cost. Therefore, wind power has become the major renewable energy resource all over the world.

In general, a conventional wind power generation system includes a propeller and a generator. The propeller is driven and rotated by wind power. The rotational speed of the propeller is increased by means of a speed increaser to drive the generator for generating electric power. A gear system is arranged between the generator and the propeller for transmitting mechanical energy of the propeller to the generator for converting the mechanical energy into electric power. This is disclosed in Taiwanese Patent No. 095148715.

The conventional wind power generation system can effectively convert mechanical energy into electric power. However, the conventional wind power generation system still has some shortcomings as follows:
1. The gear system adapted to the motor has complicated structure so that the manufacturing cost is relatively high.
2. During operation, the shaft of the gear system is apt to wear and damage. This will lead to increment of cost for later maintenance.
3. The gear system has the problem of energy loss during operation. As a result, power generation efficiency will be decreased.

### SUMMARY OF THE INVENTION

It is therefore a primary object of the present invention to provide a serial connection structure of a direct-drive motor, which is applicable to a generator or a wind power generator system without extra connecting with any transmission gear system. Therefore, the number of components is decreased, the maintenance cost is lowered and the service is simplified.

It is a further object of the present invention to provide the above serial connection structure of the direct-drive motor. A user can directly adjust one of the rotors or one of the stators and change relative position between the rotors or stators so as to overcome the problem of cogging in operation.

It is still a further object of the present invention to provide the above serial connection structure of the direct-drive motor. The number of the serially connected motors can be increased as necessary.

To achieve the above and other objects, the serial connection structure of the direct-drive motor of the present invention includes a central shaft, a housing, at least two rotors and stators of the same number as the rotors. The central shaft has a predetermined length. The housing has an internal space and is coaxially fitted around the central shaft. The rotors are received in the housing and coaxially rotatably fitted on the central shaft at predetermined intervals. The stators are received in the housing and coaxially fitted around the central shaft corresponding to the rotors respectively. The stators are spaced from the rotors by a predetermined distance.

The present invention can be best understood through the following description and accompanying drawings, wherein:

### BRIEF DESCRIPTION OF THE DRAWINGS

FIG. 1 is a perspective assembled view of a preferred embodiment of the present invention;

FIG. 2 is a perspective exploded view of the preferred embodiment of the present invention; and

FIG. 3 is a sectional view taken along line 3-3 of FIG. 1.

### DETAILED DESCRIPTION OF THE PREFERRED EMBODIMENTS

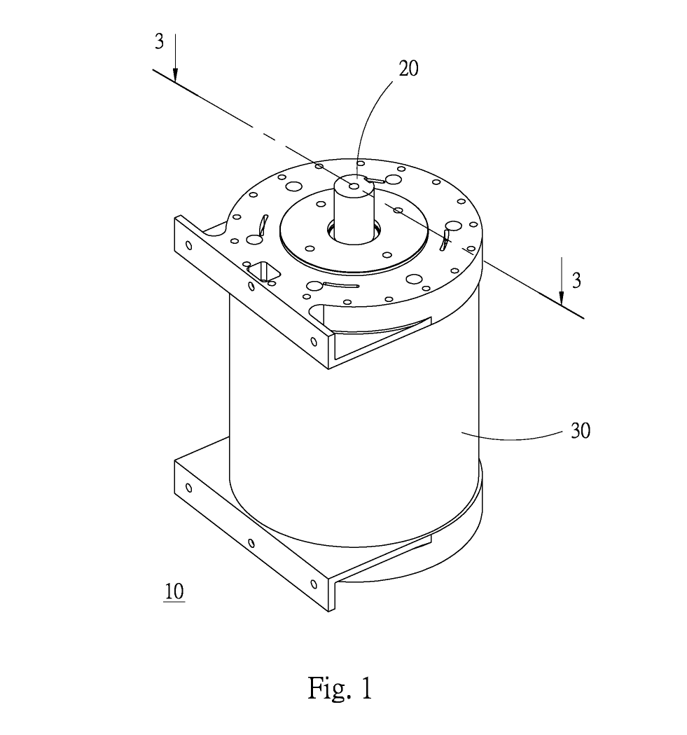

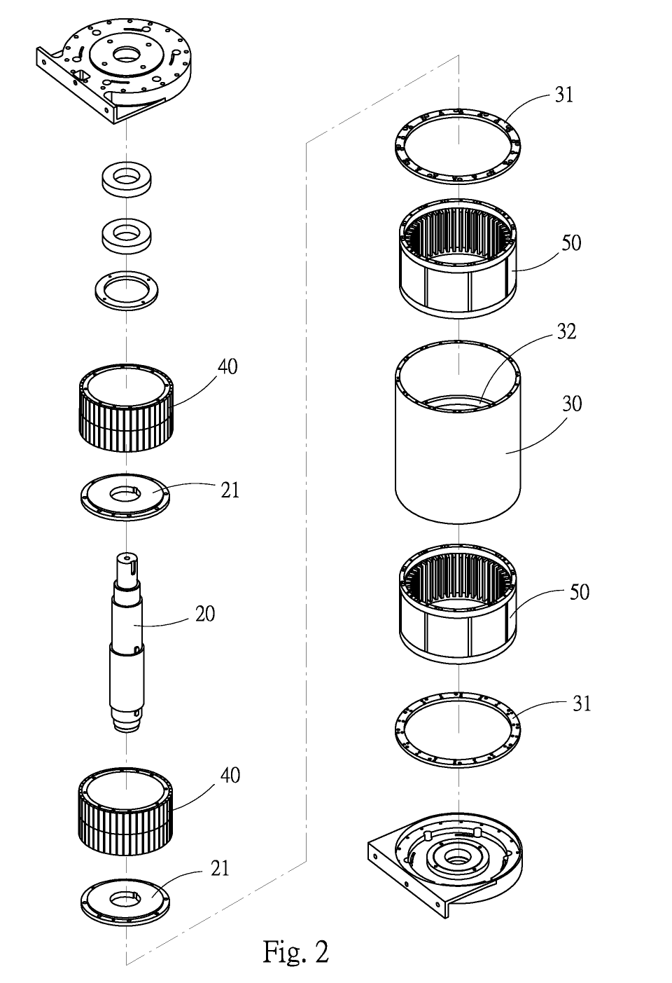

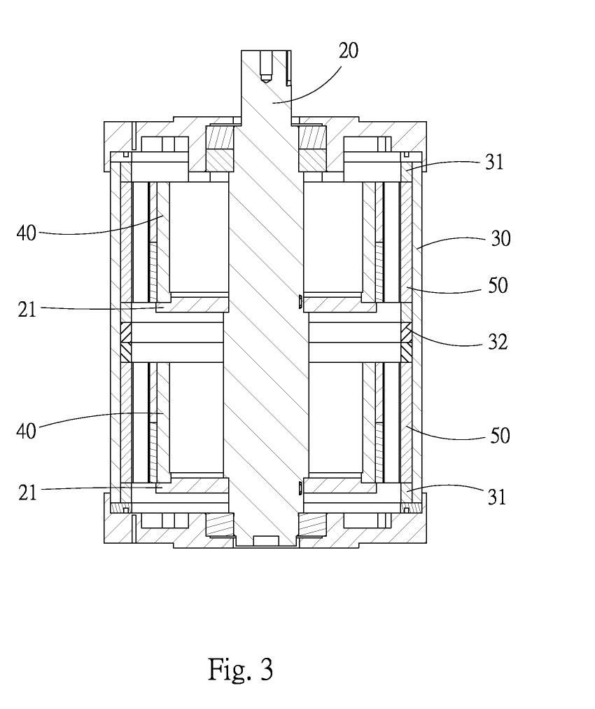

Please refer to FIGS. 1 to 3. According to a preferred embodiment, the serial connection structure 10 of the direct-drive motor of the present invention includes a central shaft 20, a housing 30, two rotors 40 and two stators 50.

The central shaft 20 is a solid rod body with a predetermined length. In practice, the central shaft 20 is stepped and has different outer diameters at different parts of its length for coupling with different transmission components. This design pertains to prior art and thus will not be further described hereinafter.

The housing 30 is a hollow tubular body having an internal space. Two locating rings 31 are respectively disposed at two axial ends of the housing 30 on inner circumference thereof. A retaining section 32 is annularly disposed on the inner circumference of a middle portion of the tubular body and protrudes from the inner circumference.

The rotors 40 have equal outer diameters. The rotors 40 are received in the housing 30 and coaxially rotatably fitted around the central shaft 20 at predetermined intervals.

The stators 50 have equal outer diameters. The stators 50 are received in the housing 30 and coaxially fitted around the central shaft 20 corresponding to the rotors 40 respectively. The stators 50 are spaced from the rotors 40 by a predetermined distance. One end of each stator 50 is connected with inner circumference of the locating ring 31 by means of multiple threaded rods. The other end of the stator 50 abuts against the retaining section 32.

Two adjustment members 21 are further fitted on predetermined portions of the central shaft 20.

The adjustment members 21 are circular disc-shaped. The curvature centers of the adjustment members 21 coincide with the axis of the central shaft 20. One end of each adjustment member 21 corresponds to one end of the rotor 40. The adjustment members 21 are respectively connected with the rotors 40 by means of multiple threaded rods.

According to the above arrangement, multiple direct-drive motors can be serially connected with the same central shaft 20. The structure is simple and the number of the motors can be increased or decreased in accordance with the requirement of energy. Moreover, in the case that cogging takes place during the operation, a user only needs to rotate one of the stators or one of the rotors by a certain angle to change the relative position between the motors. This can minimize the possibility of cogging.

The serial connection structure 10 of the present invention is applicable to a wind power generator. In the wind power generator, one end of the central shaft 20 of the serial connection structure 10 is connected with the rotary shaft of a fan for converting mechanical energy into electric power. Accordingly, the serial connection structure 10 can be directly applied to the wind power generator to generate electric power without any additional gear transmission system.

In addition, the serial connection structure 10 of the present invention is also applicable to outer rotor motors to achieve the same effect.

In comparison with the conventional device, the serial connection structure 10 of the direct-drive motor of the present invention has the following advantages:
1. The serial connection structure of the present invention is directly applicable to a wind power generator without any additional cooperative gear transmission system. Therefore, the structure is simplified and the maintenance cost is lowered.
2. A user can directly rotate one of the rotors or one of the stators to minimize the possibility of cogging in operation.
3. The number of the serially connected motors can be increased as necessary to obtain greater energy.

The above embodiments are only used to illustrate the present invention, not intended to limit the scope thereof. Many modifications of the above embodiments can be made without departing from the spirit of the present invention. For example, the numbers of the stators and the rotors or the relative position between the motors can be changed as necessary.

What is claimed is:

1. A serial connection structure of a direct-drive motor, comprising:
a central shaft with a predetermined length;
a housing, which is a hollow tubular body with a predetermined length, the housing being coaxially fitted around the central shaft;
at least two rotors received in the housing and coaxially rotatably fitted on the central shaft at predetermined intervals; and
stators of the same number as the rotors, the stators being received in the housing and coaxially fitted around the central shaft corresponding to the rotors respectively, the stators being spaced from the rotors by a predetermined distance.

2. The serial connection structure of the direct-drive motor as claimed in claim 1, wherein the central shaft has several adjustment members of the same number as the rotors, one end of each adjustment member being correspondingly connected with an axial end of the rotor.

3. The serial connection structure of the direct-drive motor as claimed in claim 1, wherein the housing has two locating rings respectively disposed at two axial ends of the housing, at least one retaining section being disposed on a predetermined portion of inner circumference of the housing.

4. The serial connection structure of the direct-drive motor as claimed in claim 2, wherein the housing has two locating rings respectively disposed at two axial ends of the housing, at least one retaining section being disposed on a predetermined portion of inner circumference of the housing.

5. The serial connection structure of the direct-drive motor as claimed in claim 1, wherein the number of the rotors is two and the rotors have equal outer diameters.

6. The serial connection structure of the direct-drive motor as claimed in claim 1, wherein the number of the stators is two and the stators have equal outer diameters.
